(19) United States
(12) Patent Application Publication
(10) Pub. No.: US 2019/0338941 A1
(43) Pub. Date: Nov. 7, 2019

(54) Lighting device for wall mounting in a domestic electrical device

(71) Applicant: emz-Hanauer GmbH & Co. KGaA, Nabburg (DE)

(72) Inventors: Manfredi Signorino, Wackersdorf (DE); Johann Schenkl, Bodenwoehr (DE)

(73) Assignee: emz-Hanauer GmbH & Co. KGaA, Nabburg (DE)

(21) Appl. No.: 16/397,017

(22) Filed: Apr. 29, 2019

(30) Foreign Application Priority Data
May 3, 2018 (DE) 102018003588.4

(51) Int. Cl. F21V 33/00; F25D 27/00; F21V 13/04; F21V 5/00

(52) U.S. Cl. CPC F21V 33/0044; F25D 27/00; F21W 2131/305; F21V 5/007; F21V 13/04

(57) ABSTRACT

A domestic refrigerator includes an interior, a vertical side delimiting wall adjoining the interior, and a vertically elongate wall light arranged upright on the delimiting wall. The wall light includes a window pane which has surface profiling in a lower end portion of its pane length but is otherwise free of such surface profiling. Behind the window pane there is arranged a reflection surface which has a diffusely reflecting action for light emitted by a light source arrangement of the wall light in the direction towards to the light reflection surface, so that the light emitted by the wall light contains at least a significant proportion of scattered light. By means of the surface profiling, the light emission pattern of the wall light can be modified in some regions.

### BACKGROUND OF THE INVENTION

### 1. Field of the Invention

The present invention relates generally to a lighting device for wall mounting in a domestic electrical device, in particular a cooling device.

### 2. Description of the Prior Art

Refrigerators used in private households generally have one or more lights by means of which the interior of the refrigerator is illuminated when the door of the refrigerator is open, so that a user is better able to see the foods stored therein. Conventional lighting solutions comprise a wall light which is mounted on a delimiting wall of the refrigerator adjoining the interior, for example at the side or at the rear, and is in the form of an indirect radiator, in which the light radiation generated by a light source arrangement of the wall light is scattered at least in part at a suitably matt or/and rough reflection surface before the resulting scattered radiation leaves the wall light through a window pane thereof and passes into the interior of the refrigerator. The light source arrangement conventionally comprises a plurality of light sources arranged in a row one behind the other. By varying the spacing of the light sources it would in principle be possible to influence the lighting characteristics of the wall light in the direction of the row of light sources, that is to say to vary the lighting characteristics of the wall light along the row of light sources. However, inasmuch as commercially available light strip material is to be used for the row of light sources, in which light-emitting diodes are arranged at regular intervals in a row on a carrier tape, a different solution must be found if a wall light whose lighting characteristics vary along the row of light sources is to be produced.

### SUMMARY OF THE INVENTION

It is an object of the invention to provide a lighting device which is intended for wall mounting in a domestic electrical device, in particular a cooling device, and allows the lighting characteristics of the lighting device to be varied along a row of light sources even if commercially available light strip material is used for the row of light sources.

In order to achieve that object, the invention starts from a lighting device for wall mounting in a domestic electrical device, in particular a cooling device, wherein the lighting device comprises: a window pane which forms a light outlet region for the emergence of light from the lighting device; a light source arrangement having a plurality of light sources, in particular of the LED type, arranged in a row one behind the other, in particular at regular intervals; and a reflection surface which is irradiated by the light sources and in particular has a diffusely reflecting action, for reflecting light in the direction towards the window pane. According to the invention, it is provided in such a lighting device that the window pane is provided with surface profiling on at least one of its pane sides within at least one part-region of the light outlet region and is free of profiling on the pane side in question within a remaining portion of the light outlet region.

By means of the surface profiling of the window pane, the light emission pattern of the lighting device can be modified in some regions along the row of light sources. For example, the direction in which light radiation from the lighting device predominantly occurs can be modified by means of the surface profiling. In this manner it is possible, for example, in a domestic refrigerator to produce an elongate wall light which is arranged upright on a side or rear delimiting wall of the cold chamber and which, in adaptation to lighting requirements which may vary over the height of the cold chamber, exhibits different light emission patterns in different portions of its length. Nevertheless, it is still possible to use for the row of light sources a commercially available light strip material in which light sources are arranged in a row at equal intervals on a carrier tape. It will be appreciated that the use of such a commercial light strip material is not an essential requirement for producing the light source arrangement within the context of the present invention. However, the invention provides a particular use on the assumption that a commercially available light strip material is used.

In particular embodiments, the window pane has surface profiling within at least one part-region of the light outlet region on the pane side that faces the reflection surface, while the window pane is free of profiling throughout on the pane side that is remote from the reflection surface.

In particular embodiments, the window pane is elongate in the direction of the row of light sources, wherein it has surface profiling in at least one portion, in particular an end portion, of its pane length and is free of profiling in at least one remaining portion of its pane length. It can thereby be provided that the surface profiling in the at least one portion extends over substantially the entire width of the light outlet region.

The surface profiling can comprise a prism structure or/and a lens structure with a plurality of prism elements or lens elements. In particular embodiments, it is provided that the window pane has an approximately rectangular pane contour with longer and shorter rectangle sides, and that at least some of the prism elements, in particular all the prism elements, extend in a direction transversely, in particular obliquely, to the longer rectangle sides of the pane contour.

The invention further provides a domestic electrical device, in particular cooling device, which comprises an interior, a delimiting wall adjoining the interior, and a lighting device of the type described above arranged on the delimiting wall. In some forms of the domestic device, the delimiting wall is a vertical delimiting wall, wherein the window pane of the lighting device is elongate in the direction of the row of light sources and is arranged upright on the delimiting wall. The window pane has surface profiling in an upper or/and a lower end portion of its pane length and is free of profiling in at least one middle portion of its pane length.

The invention will be explained further hereinbelow with reference to the accompanying drawings.

### BRIEF DESCRIPTION OF THE DRAWINGS

FIG. 1 shows, schematically, a domestic refrigerator according to an exemplary embodiment.

FIG. 2 is a top view of a wall light of the refrigerator of FIG. 1

FIG. 3 is a section along line III-III of FIG. 2.

FIG. 4 is a section along line IV-IV of FIG. 2.

FIG. 5 is a section along line V-V of FIG. 2.

### DETAILED DESCRIPTION OF THE INVENTION

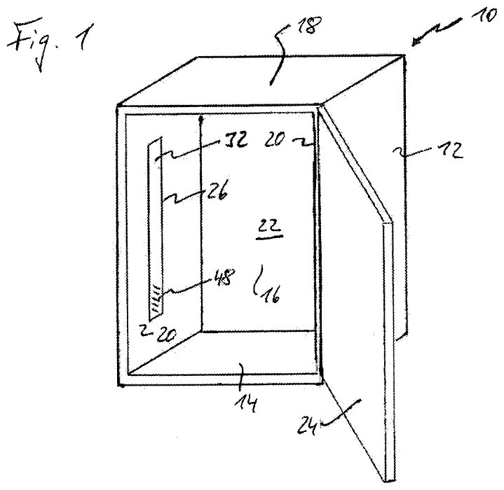

Reference will first be made to FIG. 1. The domestic refrigerator shown therein is designated generally 10. It serves for storing foods above or/and below the freezing point and comprises a main housing 12 having a horizontal bottom wall 14, a vertical rear wall 16, a horizontal top wall 18 and two mutually opposite vertical side walls 20, which together delimit an interior 22 of the refrigerator 10. A door 24 by means of which the interior 22, which forms the cold chamber of the refrigerator 10, can be closed is pivotably mounted on the main housing 12.

When the door 24 is open (as shown in FIG. 1), it is desirable to illuminate the interior 22 artificially, in order to provide the user with a better view of the foods therein. For this purpose, at least one wall light 26 is fitted to at least one of the walls 14, 16, 18, 20, which wall light is so controlled that it is switched on and off depending on the opening and closing of the door 24. In the example shown, a wall light 26 is mounted on the side wall 20 on the left in the representation of FIG. 1. This wall light 26 is in elongate form and is arranged upright on the side wall 20 in question.

The wall light 26 can extend over a significant part of the height of the interior 22, or of the height of the side wall 20, for example over at least half the height. In particular, the wall light 26 extends over a plurality of storage levels at which foods can be stored in the refrigerator 10. Such storage levels are formed in known manner, for example, by plate- or grid-like shelves, which are either permanently fitted in the interior 22 or can be inserted into insertion guides so that they are removable from the interior 22 if required and can optionally be arranged to be height-adjustable. In addition, the interior 22 can be equipped in a manner known per se with one or more pull-out drawers which likewise form a storage level, that is to say a vertical position, at which foods can be placed in the interior 22. Such drawers are often arranged at the very bottom of the cold chamber 22, while one or more of the mentioned shelves are arranged above the drawer or drawers. In particular embodiments, the wall light 26 extends as far as the bottom wall 14, so that it reaches the height region of a food drawer inserted at the very bottom of the cold chamber 22. At the same time, the wall light 26 has sufficient length that it reaches upwards into the region of at least one shelf or in particular a plurality of shelves and accordingly bridges a plurality of storage levels within the interior 22. A corresponding further wall light 26 can moreover be mounted on the other of the side walls 20 of the refrigerator 10 or/and on the rear wall 16.

It should be pointed out that the above explanations relating to the position and form of the wall light 26 are only by way of example, and that the invention is not limited to this exemplary embodiment in any way. An elongate form of the wall light 26 is not a requirement for achieving the advantages according to the invention. These advantages can likewise be achieved by arranging one or more wall lights at different locations of the walls 14, 16, 18, 20 delimiting the interior 22.

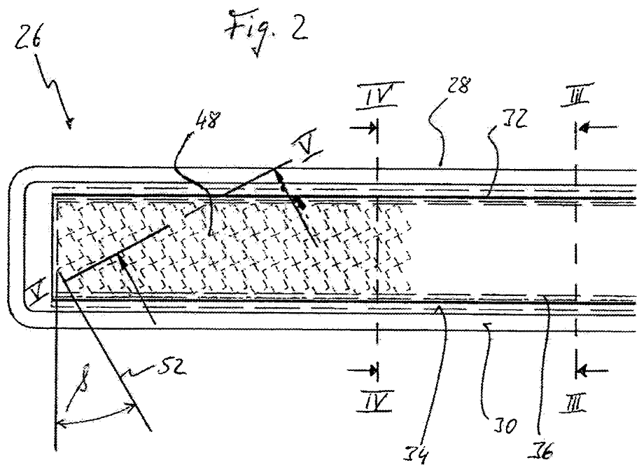

For further details of the wall light 26 shown in FIG. 1, reference will now additionally be made to FIGS. 2 to 5. In the example shown, the wall light 26 comprises a frame 28 which forms a visible surface 30 on its side facing the interior 22 and encloses all round a plate-like window element 32 manufactured from a transparent material. The window element 32 is positioned on a peripheral support surface 34 formed on the frame 28 and is fixed thereto by a welded connection or an adhesive connection, for example. The window element 32 will also be referred to hereinbelow as a window pane. In the example shown, the window pane 32 has an elongate rectangular contour corresponding to the general form of the wall light 26. The window pane 32 forms a light outlet region 36 which is delimited by the support surface 32 on the pane side that is remote from the interior and within which light from the wall light 26 is able to emerge into the interior 22. The window pane 32 directly adjoins the interior 22 with its other pane side. Although the frame 28 and the window pane 32 are formed of separately produced components in the example shown, it is of course possible to produce the frame 28 and the window pane 32 integrally in one piece. In the light outlet region 36, the window pane 32 is in the form of a transparent pane, for example. Alternatively, it can have a milky (opaque) appearance.

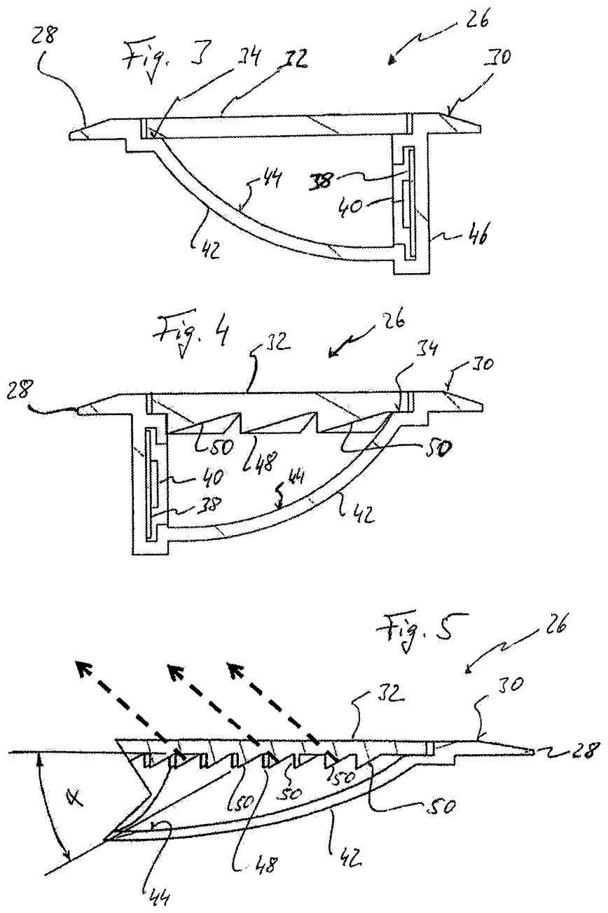

The wall light 26 further comprises a circuit board 38 on which a plurality of light sources 40 are mounted in a row one behind the other at in particular equal intervals (FIGS. 3 and 4). The row of light sources 40 extends in the direction of the longitudinal extent of the wall light 26, that is to say in the direction of the longer rectangle sides of the window pane 32. The light sources 40 are formed, for example, by white-light light-emitting diodes. The circuit board 38 with the light sources 40 mounted thereon is formed, for example, by a commercially available light strip material which is supplied in the form of wound tape rolls and can be cut to the desired length.

The wall light 26 additionally comprises a reflector body 42 which forms a reflection surface 44. The reflection surface 44 is so designed at least in a part-region of its extent, in particular over its entire extent, that it effects diffuse reflection (scattering) of light beams which are incident thereon. For example, the reflection surface 44 is for that purpose configured with a suitable surface roughness or/and with a suitably matt surface. The circuit board 38 with the light sources 40 and the reflection surface 44 are so arranged relative to one another that at least a portion of the light radiation emitted by the light sources 40 is directed at the reflection surface 44 and leaves the wall light 26 through the window pane 32 only after it has been scattered at the reflection surface 44. The light emerging from the wall light 26 accordingly contains a proportion of scattered light, it being possible for that proportion to be the majority of the light emitted in total by the wall light 26. In particular, the light emerging from the wall light 26 can consist substantially only of scattered light.

The circuit board 38 with the light sources 40 mounted thereon is held on a holding portion 46 protruding from the frame 28. In the example shown, the reflector body 42 and the frame 28 (together with the holding portion 46) are formed integrally in one piece by a common body which can be produced, for example, by injection moulding or in an extrusion process. Instead of an integral one-piece form of the frame 28 with the reflector body 42, these two components can also be formed by separately produced components.

In the refrigerator according to FIG. 1, the illumination, for example, of a pull-out food drawer inserted at the very bottom of the interior 22 can involve different requirements of the light emission characteristics, in particular the predominant light emission direction, of the wall light 26 than the illumination of the space above a shelf. In order to adapt the wall light 26 to such varying illumination requirements along its longitudinal extent, the window pane 32 is provided in one or more portions of its longitudinal extent with surface profiling 48, which in the example of the exemplary embodiment of FIGS. 2 to 5 is formed on the pane side of the window pane 32 that faces the reflector. On its pane side that is remote from the reflector, on the other hand, that is to say on the pane side at which the light emerges from the window element 32 into the interior 22, the window pane 32 in the example shown is free of profiling, that is to say is smooth and even, over its entire pane extent. The window pane 32 is additionally free of profiling on its pane side that faces the reflector outside the portion, or portions, where the surface profiling 48 is provided.

In the example shown in FIGS. 1 and 2, the window pane 32 is provided with the surface profiling 48 in a lower end portion—when viewed in the installation position—of the light outlet region 36. This end portion can extend, for example, over at least about 5% or at least about 10% or at least about 15% and not more than 50% or not more than 40% or not more than 30% of the total length of the window pane 32. In the transverse direction of the pane, that is to say in the direction along the shorter rectangle sides of the window pane 32, the surface profiling 48 extends substantially over the entire width of the light outlet region 36. It will be appreciated that, if required, the window pane 32 can also have surface profiling in the region of its opposite longitudinal end or only in the region of the upper longitudinal end. Alternatively or in addition, the window pane 32 can have surface profiling in one or more middle or intermediate regions along its pane length. If the window pane 32 has surface profiling on the same pane side in a plurality of part-regions, those part-regions are each separated from one another by a pane region without profiling.

In the example shown, the surface profiling 48 is formed by a plurality of prism elements 50, which are all arranged within the profiled portion of the window pane 32 with the same orientation in relation to the pane longitudinal direction. In the example shown, the prism elements 50 have the base area of a right-angled triangle, the base area being continued along a direction (direction of extent of the prism elements 50) which is illustrated in FIG. 2 by a directional line 52 and extends parallel to the pane plane of the window pane 32. The prism elements 50 are, for example, right prisms and all have the same shape and cross-sectional size within the profiled pane portion, for example. As can be seen in FIG. 5, one of the triangle sides of the prism elements 50 is perpendicular to the pane plane of the window pane 32; a further of the triangle sides of the prism elements 50 is oriented obliquely at an angle α to the pane plane of the window pane 32. By changing the value of the angle α and the value of an angle β (FIG. 2), which indicates the angle between the direction of extent of the prism elements 50 and the pane transverse direction, it is possible to adjust the light-deflecting effect of the surface profiling 48, in particular to set a preferential direction of the light radiation from the wall light 26 in the profiled pane portion. It will be seen in FIG. 2 that, in the example shown, the direction of extent of the prism elements 50 (represented by the directional arrow 52) extends obliquely to the pane longitudinal direction of the window pane 32. The angle β accordingly has a value less than 90 degrees and greater than 0 degrees. With such a configuration of the surface profiling 48 it is possible to direct larger proportions of the light emitted by the wall light 26 into a space laterally beneath the wall light 26 (considering the installation situation according to FIG. 1) than would be possible without the provision of the surface profiling 48. In this manner it is possible, for example, to illuminate even the rear regions of a food drawer arranged at the very bottom of the interior 22.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A lighting device for wall mounting in a domestic electrical device, in particular a cooling device, the lighting device comprising:
a window pane which forms a light outlet region for the emergence of light from the lighting device;
a light source arrangement having a plurality of light sources arranged in a row one behind the other, in particular at regular intervals; and
a reflection surface which is irradiated by the light sources and in particular has a diffusely reflecting action, for reflecting light in the direction towards the window pane,
wherein the window pane is provided with surface profiling on at least one pane side within at least one portion of the light outlet region and is free of profiling on the at least one pane side within a remaining portion of the light outlet region.

2. The lighting device according to claim 1, wherein the plurality of light sources is a LED type.

3. The lighting device according to claim 1, wherein the window pane has surface profiling within at least one portion of the light outlet region on the pane side that faces the reflection surface and is free of profiling on the pane side that is remote from the reflection surface.

4. The lighting device according to claim 1, wherein the window pane is elongate in the direction of the row of light sources and has surface profiling in at least one portion of its pane length and is free of profiling on at least one remaining portion of its pane length.

5. The lighting device according to claim 1, wherein the window pane is elongate in the direction of the row of light sources and has surface profiling in an end portion of its pane length and is free of profiling on at least one remaining portion of its pane length.

6. The lighting device according to claim 4, wherein the surface profiling in the at least one portion extends over substantially the entire width of the light outlet region.

7. The lighting device according to claim 1, wherein the surface profiling comprises a structure selected from the group consisting of a prism structure with a plurality of prism elements, a lens structure with a plurality of lens elements, and both the prism structure with the plurality of prism elements and the lens structure with the plurality of lens elements.

8. The lighting device according to claim 7, wherein the window pane has an approximately rectangular pane contour with longer and shorter rectangle sides, and in that at least some of the plurality of prism elements extend in a direction transversely to the longer rectangle sides of the pane contour.

9. The lighting device according to claim 7, wherein the window pane has an approximately rectangular pane contour with longer and shorter rectangle sides, and in that all the prism elements extend in a direction transversely to the longer rectangle sides of the pane contour.

10. The lighting device according to claim 7, wherein the window pane has an approximately rectangular pane contour with longer and shorter rectangle sides, and in that at least some of the plurality of prism elements extend in a direction obliquely to the longer rectangle sides of the pane contour.

11. The lighting device according to claim 7, wherein the window pane has an approximately rectangular pane contour with longer and shorter rectangle sides, and in that all the prism elements extend in a direction obliquely, to the longer rectangle sides of the pane contour.

12. A domestic electrical device, in particular cooling device, comprising:
an interior;
a delimiting wall adjoining the interior; and
a lighting device according to claim 1 arranged on the delimiting wall.

13. The domestic electrical device according to claim 7, wherein the delimiting wall is a vertical delimiting wall, in that a window pane of the lighting device is elongate in the direction of a row of light sources and is arranged upright on the delimiting wall, and in that the window pane has surface profiling in an upper end portion of its pane length and is free of profiling at least in a middle portion of its pane length.

14. The domestic electrical device according to claim 7, wherein the delimiting wall is a vertical delimiting wall, in that a window pane of the lighting device is elongate in the direction of a row of light sources and is arranged upright on the delimiting wall, and in that the window pane has surface profiling in a lower end portion of its pane length and is free of profiling at least in a middle portion of its pane length.

15. The domestic electrical device according to claim 7, wherein the delimiting wall is a vertical delimiting wall, in that a window pane of the lighting device is elongate in the direction of a row of light sources and is arranged upright on the delimiting wall, and in that the window pane has surface profiling in both an upper end portion and a lower end portion of its pane length and is free of profiling at least in a middle portion of its pane length.
